(19) United States
(12) Patent Application Publication
(10) Pub. No.: US 2025/0326911 A1
(43) Pub. Date: Oct. 23, 2025

(54) STORAGE-STABLE COATED PARTICLES AND THEIR PREPARATION

(71) Applicant: BASF SE, Ludwigshafen am Rhein (DE)

(72) Inventors: Anna Maria CRISTADORO, Lemfoerde (DE); Elmar POESELT, Lemfoerde (DE); Peter GUTMANN, Ludwigshafen am Rhein (DE); Lothar SEIDEMANN, Ludwigshafen am Rhein (DE); Peter GAST, Ludwigshafen am Rhein (DE); Ulrike LICHT, Ludwigshafen am Rhein (DE); Michael HARMS, Lemfoerde (DE)

(73) Assignee: BASF SE, Ludwigshafen am Rhein (DE)

(21) Appl. No.: 19/121,968

(22) PCT Filed: Oct. 17, 2023
(86) PCT No.: PCT/EP2023/078768

§ 371 Date: Apr. 17, 2025

(30) Foreign Application Priority Data
Oct. 18, 2022 (EP) 22202204.8
Jun. 28, 2023 (EP) 23182180.2

(51) Int. Cl. C08J 9/35; C08J 9/00; C08J 9/36; C08J 11/08; C09D 175/06; C09D 175/08

(52) U.S. Cl. CPC C08J 9/35; C08J 9/0061; C08J 9/365; C08J 11/08; C09D 175/06; C09D 175/08; C08J 2375/04; C08J 2375/06; C08J 2375/08

(57) ABSTRACT

The present invention relates to storage-stable coated particles and shaped bodies comprising said coated particles as well as a process for the preparation of storage-stable coated particles of a moldable thermoplastic particle foam comprising the steps of a₁) bringing the particles into contact with an aqueous polyurethane dispersion, the polyurethane having a K-value according to DIN EN ISO 1628-1 2021 in the range from higher than 50 to lower than 100, preferably from 55 to 95, resulting in at least partly coated particles: a₂) drying the coated particles. The present invention also relates to a process for the preparation of a shaped body comprising the above process as first step and a method for disposing said shaped body.

The present invention relates to storage-stable coated particles and shaped bodies comprising said coated particles as well as a process for the preparation of storage-stable coated particles of a moldable thermoplastic particle foam comprising the steps of a₁) bringing the particles into contact with an aqueous polyurethane dispersion, the polyurethane having a K-value according to DIN EN ISO 1628-1 2021 in the range from higher than 50 to lower than 100, preferably from 55 to 95, resulting in at least partly coated particles; a₂) drying the coated particles. The present invention also relates to a process for the preparation of a shaped body comprising the above process as first step and a method for disposing said shaped body.

Moldable thermoplastic particle foams are used, for example, for the production of any solid foam bodies, for example for exercise mats, body protectors, lining elements in automobile construction, sound and vibration dampers, packaging or shoe soles.

Conventionally, a mold with foam particles is filled followed by melting the individual foam particles on their surface by the action of heat and in this way to connect them to one another to form a particle foam. Thus, in addition to simple products, complex semi-finished products or molded parts with undercuts can be produced.

Moldable thermoplastic particle foams are known in the art and described, e.g., in Robin Britton (Author), Update on Moldable Particle Foam Technology, Rapra technology Ltd, 2009. Expanded thermoplastic elastomers, especially expanded thermoplastic polyurethanes (E-TPU), represent specific moldable thermoplastic particle foams.

Expanded thermoplastic elastomers are known in the art. For example, WO 2018/082984 A1 describes particle foams based on expanded thermoplastic elastomers. WO2008/087078 A1 describes hybrid systems consisting of foamed thermoplastic elastomers and polyurethanes.

An exemplary thermoplastic polymer is expanded thermoplastic polyurethane (E-TPU), which is commercially available, e.g. marketed by BASF under the name Infinergy®. E-TPU particles represent mainly to fully closed-cell particle foam. Thermoplastic polyurethane (e.g. Elastollan®) is expanded resulting in a particle foam and can be processed on standard molding machines. Thanks to its closed particle surface and the chemical nature of the used TPU, standard E-TPU grades also absorbs only low amounts of water. Like the TPU on which it is based, it can also be characterized by high breaking elongation, tensile strength and abrasion resistance, combined with good chemical resistance.

Fast prototyping of 3D objects made out of expanded thermoplastic elastomers is nowadays not easy to realize. Typically, isocyanate-containing binders are used for bonding the particles or water vapor and appropriate machines, like a steam chest molder. Both approaches are not easily accessible due to health safety reasons, energy costs or due to lack of accessibility of appropriate machinery (steam-chest molder). Moreover, the use of water vapor allows only molding particles of the same kind, whereas a coating on an E-TPU particle or the usage of a water-based binder may allow bonding E-TPU particles of different kind (Glass transition temperature, Melting point) and size, but also bonding of different TPUs or even different particle foams, e.g. different mixtures of E-TPS, E-PS, E-PP, E-TPA, E-TPC, E-TPO and the like. The application of a coating allows as well the adjustment of the mechanical performance and applicability by incorporation of additivities, like for example pigments or dyes, flame retardants or antistatic agents, directly to the particle surface. Filling agents for example allow the increase of the stiffness of the final part, while the use of additives which are for example excitable by an electro-magnetic field allow the moldability of the coating and thereby reducing the required energy for molding.

As additives can be used pigments, dyes, odor, filling agents, bio-based and/or biodegradable additives, UV-, heat-stabilizer, flame retardants such as expandable graphite, additives which generate antistatic properties, electrical conductivity, additives, which reduce dirt-uptake, antimicrobial additives, wax, crosslinking agents, surface functionalized fillers, foamable additives such as Expancell, additives which can be irradiated by an electromagnetical field, and/or radiofrequency, and/or microwave.

WO 2022/223438 A1 describes different water-based binders for coating particles that can be brought into the shape of said 3D parts.

U.S. Pat. No. 6,616,797 B1 describes the formation of adhesive bonds by a process that includes applying a dispersion containing a polyurethane which has structural units of formula (I) to a surface. The dispersion is first coated onto the surface to form a coating. The coating is dried to give an essentially anhydrous coating. The dried coating is then subjected to heat activation. The adhesive bond is formed by joining the heat-activated coating to itself or to another surface. However, particle coating is not described.

WO 2012/13506 A1 describes the use of an aqueous polyurethane dispersion adhesive for producing biologically disintegratable composite films with at least two substrates being bonded to one another using the polyurethane dispersion adhesive, with at least one of the substrates being a biologically disintegratable polymer film. At least 60% by weight of the polyurethane is made up of diisocyanates, polyester diols and at least one bifunctional carboxylic acid selected from dihydroxycarboxylic acids and diaminocarboxylic acids.

WO 2005/003247 A1 relates to a method for bonding substrates with different surface energies. The adhesive used for bonding consists of at least 15% by weight of a polyurethane (water or other organic solvents with a boiling point below 150° C. at 1 bar not counted), the adhesive is applied to the substrate with the lower surface energy and the resulting adhesive-coated substrate is bonded to the substrate with the higher surface energy.

WO2021/7249749 describes the recycling of bonded articles, including TPU-foam substrates, by using aqueous polyurethane dispersions of specified molecular weights as adhesives. It is not mentioned, that the foamed particles are coated.

Even though different binders are described, which are generally useful for bonding particles, there is a need for the preparation of storage stable coated particles, where agglomeration of stored particles is prevented. This includes particles with better flowability, lower electrostatic charging by friction, and which allow a much easier realization of 3 D part by using an easy molding process (e.g. standard convective oven or heat press).

Accordingly, there is a need for a material that should combine the following advantages:
a) Reduction of the binder-quantity by generation of only a thin and solid surface-layer
b) Storage-stability of the beads without agglomeration
c) Easy and versatile processibility
d) Performance adjustability

While an adhesive-particle mixture shows a certain viscosity, the solid coating of the particles allows easy filling into e.g. molds or cavities during processing due to better flowability and lower electrostatic charging by friction.

Additionally, the particles can be processed differently e.g. by standard convective oven or heat press but also by an electro-magnetic field. Thereby the beads can be filled for example into interspaces and be glued together by a trigger.

Thus, an object of the present invention is to provide a process for the preparation of storage-stable coated particles.

The object is achieved by a process for the preparation of storage-stable coated particles of a moldable thermoplastic particle foam comprising the steps of
a₁) bringing the particles into contact with an aqueous polyurethane dispersion, the polyurethane having a K-value according to DIN EN ISO 1628-1 2021 in the range from higher than 50 to lower than 100, preferably from 55 to 95, resulting in at least partly coated particles;
a₂) drying the coated particles.

Another aspect of the present invention is a storage-stable, at least partly coated particle of a moldable thermoplastic particle foam, wherein the coating is a dried aqueous polyurethane dispersion, the polyurethane having a K-value according to DIN EN ISO 1628-1 2021 in the range from higher than 50 to lower than 100, preferably from 55 to 95. A preferred at least partly coated particle of the moldable thermoplastic particle foam according to the present invention is obtainable from the process of coating according to the present invention.

Another aspect of the present invention is a shaped body comprising storage-stable, at least partly coated particles according to the present invention. A preferred shaped body of the present invention is obtainable by a process of the preparation of a shaped body according to the present invention.

Surprisingly it was found that a polyurethane in an aqueous dispersion of the polyurethane having the above K-value could be used for realization of 3 D parts without the need of steam. The coating allows by heat press the realization of 3 D parts with excellent mechanical values, which are comparable and even superior to 3D parts made by using standard steam chest molding processes.

Especially, preferred dispersions used for the process of the present invention can have high solid content (>40%), but still show low viscosity. This allows an easy application of the dispersions to the particles. The particles are homogenously coated with a transparent coating, which is tack free at room temperature. On the other hand, when the particles are heated under compression, such as in a hot press process, the coating melts and allows bridging of beads upon cooling. Only moderate heat is required.

Moreover, the coated particles show surprisingly an improved flow behavior, which is a very important factor when particles are stored for long time, e.g. in octabins, as a clogging of the particles during storage causes unpleasant problems at the customer site, additional to very interesting antistatic properties.
A coating on the surface of the particles has moreover additional advantages: Particles of different sizes and chemistry (e.g. E-TPU, E-TPS, E-PS, E-TPO, E-PP, E-TPA, E-TPC) can be bond together as the adhesive capability comes from the coating and not from the melting of the wall of the particles. This has the advantage that also particles with high melting point can be worked at a temperature of, e.g. 100° C. into a 3 D part in a steam-less process.
A hot-press can be used with the advantage that steam can be avoided, and low temperature of mold can be used. This results in energy saving and a complexity reduction.
Additives can be mixed with the coating and places directly to the beads surface (surface modification. Interesting additives are heat conductive particles, antistatic particle, flame retardants, dyes, UV stabilizers, ferromagnetic particles, anticaking agents, etc.)

Particles coated with the polyurethane dispersions described herein in a 3 D part (shaped body) can be disassembled, when water-re-dispersible dispersions are used, e.g. by exposing the 3 D part to alkaline conditions under stirring.

In the realization of a 3D-part, another material (e.g. textile, leader, thermoplastic film, metallic parts) can be bonded in one-step to the particles. This allows realization of a variety of hybrid materials for different applications (sport (shoes) and leisure, automotive interior, electronic applications, flooring sheets)

Although not preferred, the coated particles can still be worked with a standard steam chest mold process or other heating processes using high energy radiation to increase temperature of the coating as described in EP 3 338 984 B1 for expanded beads, so they are compatible with already existing customer equipment.

The process allows realization of 3 D parts of very complex geometries. The 3 D parts can still have empty spaces among the particles (allowing water penetration) or can have no empty spaces among the beads, which is high desirable for the fabrication of shoe soles).

The process of the present invention refers to the preparation of coated particles of a moldable thermoplastic particle foam. Such foams are known in the art (see e.g. Robin Britton (Author), Update on Mouldable Particle Foam Technology, Rapra technology Ltd, 2009). Preferably, the moldable thermoplastic particle foam is an expanded thermoplastic elastomer.

Particles of expanded thermoplastic elastomers are known in the art. Suitable thermoplastic elastomers are, for example, thermoplastic polyurethanes (TPU), thermoplastic polyester elastomers (e.g. polyetherester and polyesterester) (TPC), thermoplastic copolyamides (e.g. Polyether copolyamides) (TPA), thermoplastic polyolefins (TPO) or thermoplastic styrene butadiene block copolymers (TPS). Foam particles based on thermoplastic polyurethane (TPU) are particularly preferred. Thus, preferably the expanded thermoplastic elastomer is E-TPU.

Examples of methods for preparing expanded thermoplastic elastomer particles are described in WO 2008/087078 A1, WO 2018/082984 A1, U.S. Pat. No. 10,005,218 B2 and WO 2007/082838 A1.

Preferably, the aqueous polymer dispersion used in the process of the present invention has a solid content of at least 40 wt.-% based on the total weight of the dispersion, more preferably in the range of from 45 wt.-% to 60 wt.-% based on the total weight of the dispersion.

Preferably, the polyurethane of the aqueous polymer dispersion and comprised in the at least partly coated particle and shaped body according to the present invention has a viscosity of less than 300 mPas at 23° C., preferably less than 200 mPas at 23° C., measured according to DIN EN ISO 3219-2:2021 at 23° C. and a shear rate of 250 s⁻¹.

Preferably, the polyurethane of the aqueous polyurethane dispersion and comprised in the at least partly coated particle and shaped body according to the present invention has a glass transition temperature T_{g} of below 0° C., more preferably from −10° C. to −80° C., even more preferably, from −20° C. to −75° C., even more preferably from −30° C. to −70° C., even more preferably from −40° C. to −65° C., even more preferably, from −45° C. to −60° C.

The glass transition temperature can be determined by differential scanning calorimetry according to DIN EN ISO 11357-2 (2014), as so-called midpoint temperature). The glass transition temperature of the polymer in the polymer dispersion is the glass transition temperature obtained when evaluating the second heating curve (heating rate 20° C./min).

In a preferred embodiment of the present invention, the polyurethane has at least a first glass transition temperature T_{g1} and a second glass transition temperature T_{g2}, wherein T_{g1} is below 0° C. and T_{g2} is higher than 25° C. More preferably, T_{g2} is higher than 40° C., even more preferably higher than 50° C., even more preferably higher than 60° C. Typically, the polyurethane of the aqueous polyurethane dispersion has a T_{g1} from −10° C. to −60° C. and a T_{g2} from 60° C. to 90° C. Preferably, the polyurethane has exactly two T_{g}.

Preferably, the polyurethane of the aqueous polyurethane dispersion and comprised in the at least partly coated particle and shaped body according to the present invention has a melting temperature Tₘ of in the range from 30° C. to 100° C., preferably from 40° C. to 80° C.

Melting-points and enthalpy of fusion are determined according to DIN EN ISO 11357-3 (2018) (melting point=peak temperature) by heating with 20 K/min after cooling to −80° C.; while enthalpy of fusion of the second run (Delta H2) is calculated from the area of second melting only.

T_{g} and Tₘ of the aqueous polyurethane dispersion means according to the present invention that the polyurethane comprised in the aqueous polyurethane dispersion has these T_{g} and Tₘ values.

In general, the aqueous polyurethane dispersion used in the process of the present invention can be prepared by methods known in the art. Exemplary methods are described in WO 2021/249749 A1

Accordingly, an aqueous polyurethane dispersion comprises at least one polyurethane as polymeric binder dispersed in water, and optionally additives. Preferred additives are selected from the group consisting of ionic surfactants, non-ionic surfactants, rheology modifiers (including thickeners), anti-blocking additives, other aqueous dispersions, cross-linkers, plasticizers, stabilizers against hydrolytic degradation, biocides, fillers and antifoam agents. The polymeric binder preferably takes the form of dispersion in water or else in a mixture made of predominantly water and of water-soluble organic solvents with boiling points, which are preferably below 150° C. (1 bar). Particular preference is given to water as sole solvent.

The polyurethane dispersion used in the process of the invention and comprised in the at least partly coated particle and shaped body according to the present invention comprises at least one polyurethane. Suitable polyurethanes are obtainable in principle through reaction of at least one polyisocyanate with at least one compound, which has at least two groups reactive toward isocyanate groups. Polyurethanes also encompass what are called polyurethane-polyureas, which as well as polyurethane groups also have urea groups as well.

The polyurethane dispersion, the at least partly coated particle and shaped body according to the present invention preferably comprises at least one polyurethane which comprises in copolymerized form at least one polyisocyanate and at least one polyol. The polyurethane dispersion and the at least partly coated particle and shaped body according to the present invention preferably comprise at least one polyurethane which comprises in copolymerized form at least one polyisocyanate and a diol component, of which a) 10-100 mol %, based on the total amount of the diols, have a molecular weight of 500 to 5000 g/mol and b) 0-90 mol %, based on the total amount of the diols, have a molecular weight of 60 to less than 500 g/mol. Polymeric polyols are preferred. Suitable polymeric polyols are preferably selected from polyester diols, polyether diols, and mixtures thereof. The polymeric polyol preferably has a number-average molecular weight in the range from about 500 to 5000 g/mol.

The polyurethane is preferably synthesized to an extent of at least 40% by weight, more preferably at least 60% by weight, and very preferably at least 80% by weight, based on the total weight of the monomers used in preparing the polyurethane, of at least one diisocyanate and at least one polyether diol and/or polyester diol. Suitable further synthesis components to 100% by weight are, for example, the below-specified polyisocyanates having at least three NCO groups, and compounds that are different from the polymeric polyols and have at least two groups reactive toward isocyanate groups. These include, for example, non-polymeric diols; diamines; polymers different from polymeric polyols and having at least two active hydrogen atoms per molecule; compounds which have two active hydrogen atoms and at least one ionogenic or ionic group per molecule; and mixtures thereof.

The polyurethane of the aqueous polyurethane dispersion adhesive preferably has crystallinity.

Preferred polyurethanes are synthesized from:
a) at least one monomeric diisocyanate,
b) at least one diol, component (b) comprising at least one diol having a number-average molecular weight in the range from 500 to 5000 g/mol,
c) at least one monomer, different from the monomers (a) and (b), having at least one isocyanate group or at least one group reactive toward isocyanate groups, and additionally carrying at least one hydrophilic group or potentially hydrophilic group,
d) optionally at least one further compound, different from the monomers (a) to (c), having at least two reactive groups selected from alcoholic hydroxyl groups, primary or secondary amino groups or isocyanate groups, and
e) optionally at least one monofunctional compound, different from the monomers (a) to (d), having a reactive group which is an alcoholic hydroxyl group, a primary or secondary amino group or an isocyanate group.

Preferably, the polyurethane dispersion is an anionic polyurethane dispersion made with low amount of aromatic diisocyanates or no aromatic diisocyanates, e.g. less than 60 mol %, based on the sum of all organic diisocyanates a). The anionic groups of the anionic polyurethane are preferably selected from carboxylate groups and sulfonate groups. The same applies to the polyurethane comprised in the at least partly coated particle and shaped body according to the present invention.

Component b) is composed preferably of
b1) 10 to 100 mol %, based on the total amount of component b), of diols having a molecular weight from 500 to 5000 g/mol,
b2) 0 to 90 mol %, based on the total amount of component b), of diols having a molecular weight of 60 to less than 500 g/mol.

The molar ratio of the diols b1) to the monomers b2) is more preferably 1:5 to 5:1, more preferably 1:2 to 2:1. More preferably, no b2) is used. More particularly the diol b) is selected from polytetrahydrofuran, polypropylene oxide and polyester diols selected from reaction products of dihydric alcohols with dibasic carboxylic acids, and lactone-based polyester diols.

Particular mention may be made as monomers (a) of diisocyanates X(NCO)₂, where X is a noncyclic aliphatic hydrocarbon radical having 4 to 15 carbon atoms, a cycloaliphatic or aromatic hydrocarbon radical having 6 to 15 carbon atoms, or an araliphatic hydrocarbon radical having 7 to 15 carbon atoms. Examples of such diisocyanates include tetramethylene diisocyanate, hexamethylene diisocyanate (HDI), dodecamethylene diisocyanate, 1,4-diiso-cyanatocyclohexane, 1-isocyanato-3,5,5-trimethyl-3-isocyanatomethyl-cyclohexane (IPDI), 2,2-bis(4-isocyanatocyclohexyl)-propane, trimethylhexane diisocyanate, 1,4-diisocyanatobenzene, 2,4-diisocyanatotoluene, 2,6-diisocyanatotoluene (TDI), 4,4′-diisocyanato-diphenylmethane, 2,4′-diisocyanatodiphenylmethane, p-xylylene diisocyanate, tetramethylxylylene diisocyanate (TMXDI), the isomers of bis(4-isocyanatocyclohexyl)methane (HMDI) such as the trans/trans, the cis/cis, and the cis/trans isomers, and mixtures of these compounds. Diisocyanates of this kind are available commercially. With particular preference the diisocyanate is selected from the group consisting of hexamethylene diisocyanate, 1-isocyanato-3,5,5-trimethyl-3-isocyanatomethyl-cyclohexane, 2,6-diisocyanatotoluene, and tetramethylxylylene diisocyanate, or a mixture thereof. Particularly important mixtures of these isocyanates are the mixtures of the respective structural isomers of diisocyanatotoluene and diisocyanatodiphenylmethane; the mixture of 80 mol % 2,4-diisocyanatotoluene and 20 mol % 2,6-diisocyanatotoluene is particularly suitable. Also of particular advantage are the mixtures of aromatic isocyanates such as 2,4-diisocyanatotoluene and/or 2,6-diisocyanatotoluene with aliphatic or cycloaliphatic isocyanates such as hexa-methylene diisocyanate or IPDI, in which case the preferred molar mixing ratio of the aliphatic to the aromatic isocyanates is 1:9 to 9:1, more particularly 4:1 to 1:4. It is also preferred that only aliphatic isocyanates are used.

The diols (b1) may be polyester polyols, which are known, for example, from Ullmanns Enzyklopadie der technischen Chemie, 4th edition, volume 19, pp. 62 to 65. It is preferred to use polyester polyols which are obtained by reacting dihydric alcohols with dibasic carboxylic acids. Instead of the free polycarboxylic acids it is also possible to use the corresponding polycarboxylic anhydrides or corresponding polycarboxylic esters of lower alcohols or mixtures thereof to prepare the polyester polyols. The polycarboxylic acids can be aliphatic, cyclo aliphatic, araliphatic, aromatic or heterocyclic and can optionally be substituted, by halogen atoms for example, and/or unsaturated. Examples thereof include the following: suberic acid, azelaic acid, phthalic acid, isophthalic acid, phthalic anhydride, tetrahydrophthalic anhydride, hexahydrophthalic anhydride, tetrachlorophthalic anhydride, endomethylene tetrahydrophthalic anhydride, glutaric anhydride, maleic acid, maleic anhydride, fumaric acid, and dimeric fatty acids. Preferred dicarboxylic acids are those of the general formula HOOC—(CH₂)_{y}—COOH, where y is a number from 1 to 20, preferably an even number from 2 to 20, examples being succinic acid, adipic acid, sebacic acid, and dodecane dicarboxylic acid. Examples of suitable dihydric alcohols include ethylene glycol, propane-1,2-diol, propane-1,3-diol, butane-1,3-diol, butene-1, 4-diol, butyne-1,4-diol, pentane-1, 5-diol, neopentyl glycol, bis(hydroxymethyl) cyclohexanes such as 1,4-bis(hydroxymethyl)cyclohexane, 2-methylpropane-1,3-diol, methylpentanediols, and also diethylene glycol, triethylene glycol, tetraethylene glycol, polyethylene glycol, dipropylene glycol, polypropylene glycol, and dibutylene glycol and polybutylene glycols. To obtain crystallinity preferred alcohols are those of the general formula HO—(CH₂)ₓ—OH, where x is a number from 1 to 20, preferably an even number from 2 to 20. Examples of such alcohols are ethylene glycol, butane-1,4-diol, hexane-1,6-diol, octane-1, 8-diol, and dodecane-1,12-diol.

The diols (b1) may also be polycarbonate diols, such as may be obtained, for example, by reacting phosgene with an excess of the low molecular weight alcohols specified as synthesis components for the polyester polyols.

The diols (b1) may also be lactone-based polyester diols, which are homopolymers or copolymers of lactones, preferably hydroxyl-terminated adducts of lactones with suitable difunctional starter molecules.

To obtain crystallinity, preferred lactones contemplated are those derived from compounds of the general formula HO—(CH₂)_{z}—COOH, where z is a number from 1 to 20 and where one or more H atoms of a methylene unit may also be substituted by a C1 to C4 alkyl radical. Examples are epsilon-caprolactone, beta-propiolactone, gamma-butyrolactone and/or methyl-gammacaprolactone, and mixtures thereof. Examples of suitable starter components are the low molecular weight dihydric alcohols specified above as a synthesis component for the polyester polyols. The corresponding polymers of epsilon-caprolactone are particularly preferred. Lower polyester diols or polyether diols as well can be used as starters for preparing the lactone polymers. Instead of the polymers of lactones it is also possible to use the corresponding chemically equivalent polycondensates of the hydroxycarboxylic acids corresponding to the lactones.

The diols (b1) may also be polyether diols. Polyether diols are obtainable in particular by polymerizing ethylene oxide, propylene oxide, butylene oxide, tetrahydrofuran, styrene oxide or epichlorohydrin with itself, in the presence of BF3 for example, or by subjecting these compounds, optionally in a mixture or in succession, to addition reaction with starter components containing reactive hydrogen atoms, such as alcohols or amines, examples being water, ethylene glycol, propane-1,2-diol, propane-1,3-diol, 2,2-bis(4-hydroxyphenyl)propane, and aniline. Particular preference is given to polyether diols with a molecular weight of 500 to 5000, and in particular 600 to 4500. A particularly preferred polyether diol is polytetrahydrofuran. Suitable polytetrahydrofurans can be prepared by cationic polymerization of tetrahydrofuran in the presence of acidic catalysts, such as sulfuric acid or fluorosulfuric acid, for example. Preparation processes of this kind are known to the skilled person.

Compounds subsumed under b1) include only those polyether diols composed to an extent of less than 20% by weight of ethylene oxide, based on their total weight. Polyether diols with at least 20% by weight of incorporated ethylene oxide units are hydrophilic polyether diols, which are counted as monomers c).

It is also possible to use polyhydroxyolefins, preferably those having 2 terminal hydroxyl groups, e.g., α,ω-dihydroxypolybutadiene, α,ω-dihydroxypolymethacrylic esters or α,ω-dihydroxypolyacrylic esters, as monomers bi). Such compounds are known for example from EP-A 622 378. Further suitable polyols are polyacetals, polysiloxanes, and alkyd resins.

The hardness and the elasticity modulus of the polyurethanes can be increased by using as diols (b) not only the diols (b1) but also low molecular weight diols (b2) having a molecular weight of from about 60 to less than 500, preferably from 62 to 200 g/mol.

Monomers (b2) used are in particular the synthesis components of the short-chain alkane diols specified for preparing polyester polyols, preference being given to the unbranched diols having 2 to 12 C atoms and an even number of C atoms, and also to pentane-1, 5-diol and neopentyl glycol. Examples of suitable diols b2) include ethylene glycol, propane-1,2-diol, propane-1, 3-diol, butane-1,3-diol, butene-1,4-diol, butyne-1,4-diol, pentane-1, 5-diol, neopentyl glycol, bis-(hydroxymethyl)cyclohexanes such as 1,4-bis(hydroxymethyl)cyclohexane, 2-methylpropane-1, 3-diol, methyl pentane diols, additionally diethylene glycol, triethylene glycol, tetraethylene glycol, polyethylene glycol, dipropylene glycol, polypropylene glycol, dibutylene glycol, and polybutylene glycols. To obtain crystallinity, preference is given to alcohols of the general formula HO—(CH₂)ₓ—OH, where x is a number from 1 to 20, preferably an even number from 2 to 20. Examples thereof are ethylene glycol, butane-1,4-diol, hexane-1,6-diol, octane-1, 8-diol, and dodecane-1,12-diol.

In order to make the polyurethanes dispersible in water they comprise as synthesis components monomers (c), which carry at least one isocyanate group or at least one group reactive toward isocyanate groups and, furthermore, at least one hydrophilic group or a group which can be converted into a hydrophilic group. In the text below, the term “hydrophilic groups or potentially hydrophilic groups” is abbreviated to “(potentially) hydrophilic groups”. The (potentially) hydrophilic groups react with isocyanates at a substantially slower rate than do the functional groups of the monomers used to synthesize the polymer main chain. The fraction of the components having (potentially) hydrophilic groups among the total quantity of components (a) to (e) is generally such that the molar amount of the (potentially) hydrophilic groups, based on the amount by weight of all monomers (a) to (e), is from 30 to 1000, preferably 50 to 500, and more preferably 80 to 300 mmol/kg. The (potentially) hydrophilic groups can be nonionic or, preferably, (potentially) ionic hydrophilic groups.

Particularly suitable nonionic hydrophilic groups are polyethylene glycol ethers composed of preferably 5 to 100, more preferably 10 to 80 repeating ethylene oxide units. The amount of polyethylene oxide units is generally 0 to 10%, preferably 0 to 6% by weight, based on the amount by weight of all monomers (a) to (e). Preferred monomers containing nonionic hydrophilic groups are polyethylene oxide diols containing at least 20% by weight of ethylene oxide, polyethylene oxide monools, and the reaction products of a polyethylene glycol and a diisocyanate which carry a terminally etherified polyethylene glycol radical. Diisocyanates of this kind and processes for preparing them are specified in U.S. Pat. Nos. 3,905,929 and 3,920,598.

Ionic hydrophilic groups are, in particular, anionic groups such as the sulfonate, the carboxylate, and the phosphate groups in the form of their alkali metal salts or ammonium salts, and also cationic groups such as ammonium groups, especially protonated tertiary amino groups or quaternary ammonium groups. Potentially ionic hydrophilic groups are, in particular, those which can be converted into the abovementioned ionic hydrophilic groups by simple neutralization, hydrolysis or quaternization reactions, in other words, for example, carboxylic acid groups or tertiary amino groups. (Potentially) ionic monomers (c) are described at length in, for example, Ullmanns Enzyklopadie der technischen Chemie, 4th edition, volume 19, pp. 311-313 and in, for example, DE-A 1 495 745. Acid groups of the polyurethane are neutralized preferably to an extent of at least 10 mol %, more preferably at least 40 mol %, more preferably at least 70 mol %, very preferably at least 90 mol %, and more particularly completely (100 mol %) with a suitable neutralizing agent, and are therefore present in salt form, with the acid group being the anion and with the neutralizing agent being present as cation. Neutralizing agents are, for example, ammonia, alkali metal hydroxides such as NaOH or KOH, or alkanol-amines. Of particular practical importance as (potentially) cationic monomers (c) are, in particular, monomers containing tertiary amino groups, examples being tris(hydroxyalkyl)amines, N,N′-bis(hydroxyalkyl)alkylamines, N-hydroxyalkyldialkylamines, tris(aminoalkyl)amines, N,N′-bis(aminoalkyl)alkylamines, and N-aminoalkyldialkylamines, the alkyl radicals and alkanediyl units of these tertiary amines consisting independently of one another of 1 to 6 carbon atoms. Also suitable are polyethers containing tertiary nitrogen atoms and preferably two terminal hydroxyl groups, such as are obtainable in a conventional manner, for example, by alkoxylating amines containing two hydrogen atoms attached to amine nitrogen, such as methylamine, aniline or N,N′-dimethylhydrazine. Polyethers of this kind generally have a molar weight of between 500 and 6000 g/mol. These tertiary amines are converted into the ammonium salts either with acids, preferably strong mineral acids such as phosphoric acid, sulfuric acid, hydrohalic acids, or strong organic acids, or by reaction with suitable quaternizing agents such as Ci to C6 alkyl halides or benzyl halides, e.g., bromides or chlorides.

Suitable monomers having (potentially) anionic groups normally include aliphatic, cycloaliphatic, araliphatic or aromatic carboxylic acids and sulfonic acids which carry at least one alcoholic hydroxyl group or at least one primary or secondary amino group. Preference is given to dihydroxyalkylcarboxylic acids, especially those having 3 to 10 C atoms, such as are also described in U.S. Pat. No. 3,412,054. Particular preference is given to compounds of the general formula (c1)

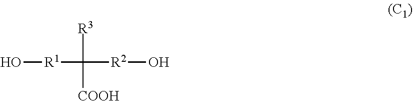

in which R¹ and R² are a C₁ to C₄ alkanediyl (unit) and R³ is a C₁ to C₄ alkyl (unit), and especially to dimethylolpropionic acid (DMPA). Also suitable are corresponding dihydroxysulfonic acids and dihydroxyphosphonic acids such as 2,3-dihydroxypropanephosphonic acid. Otherwise suitable are dihydroxyl compounds having a molecular weight of more than 500 to 10000 g/mol and at least 2 carboxylate groups, which are known from DE-A 39 11 827. They are obtainable by reacting dihydroxyl compounds with tetracarboxylic dianhydrides such as pyromellitic dianhydride or cyclopentanetetracarboxylic dianhydride in a molar ratio of 2:1 to 1.05:1 in a polyaddition reaction. Particularly suitable dihydroxyl compounds are the monomers (b2) cited as chain extenders and also the diols (b1).

Suitable monomers (c) containing amino groups reactive toward isocyanates include aminocarboxylic acids such as lysine, b-alanine or the adducts of aliphatic diprimary diamines with alpha,beta-unsaturated carboxylic or sulfonic acids that are specified in DE-A 20 34479. Such compounds obey, for example, the formula (c2)

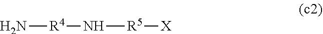

where R⁴ and R⁵ independently of one another are a C₁ to C₆ alkanediyl unit, preferably ethylene and X is COOH or SO3 H. Particularly preferred compounds of the formula (c2) are N-(2-aminoethyl)-2-aminoethanecarboxylic acid and also N-(2-aminoethyl)-2-aminoethane-sulfonic acid and the corresponding alkali metal salts, with Na being a particularly preferred counterion. Also particularly preferred are the adducts of the abovementioned aliphatic diprimary diamines with 2-acrylamido-2-methylpropanesulfonic acid, as described for example in DE-B 1 954090. Where monomers with potentially ionic groups are used, their conversion into the ionic form may take place before, during or, preferably, after the isocyanate polyaddition, since the ionic monomers do not frequently dissolve well in the reaction mixture. Examples of neutralizing agents include ammonia, NaOH, triethanolamine (TEA), triisopropylamine (TIPA) or morpholine, or its derivatives. The sulfonate or carboxylate groups are more preferably in the form of their salts with an alkali metal ion or ammonium ion as counterion.

The monomers (d), which are different from the monomers (a) to (c) and which may also be constituents of the polyurethane, may serve for crosslinking or chain extension. They may comprise nonphenolic alcohols with a functionality of more than 2, amines having 2 or more primary and/or secondary amino groups, and compounds which as well as one or more alcoholic hydroxyl groups carry one or more primary and/or secondary amino groups. Alcohols having a functionality of more than 2, which may be used in order to set a certain degree of branching or crosslinking, include for example trimethylolpropane, glycerol, or sugars. Other suitable compounds (d) are alpha, omega-diaminopolyethers, which are preparable by aminating polyalkylene oxides with ammonia. Compounds (d) are, for example, also isocyanates, which as well as free isocyanate groups carry further, masked isocyanate groups, e.g., uretdione groups or carbodiimide groups.

Also suitable are monoalcohols which as well as the hydroxyl group carry a further isocyanate-reactive group, such as monoalcohols having one or more primary and/or secondary amino groups, monoethanolamine for example. Polyamines having 2 or more primary and/or secondary amino groups are used especially when the chain extension and/or crosslinking is to take place in the presence of water, since amines generally react more quickly than alcohols or water with isocyanates. This is frequently necessary when the desire is for aqueous dispersions of crosslinked polyurethanes or polyurethanes having a high molar weight. In such cases the approach taken is to prepare prepolymers with isocyanate groups, to disperse them rapidly in water, and then to subject them to chain extension or crosslinking by adding compounds having two or more isocyanate-reactive amino groups.

Amines suitable for this purpose are generally polyfunctional amines of the molar weight range from 32 to 500 g/mol, preferably from 60 to 300 g/mol, which comprise at least two amino groups selected from the group consisting of primary and secondary amino groups. Examples of such amines are diamines such as diaminoethane, diaminopropanes, diaminobutanes, diaminohexanes, piperazine, 2,5-dimethylpiperazine, amino-3-aminomethyl-3, 5, 5-trimethyl-cyclohexane (isophoronediamine, IPDA), 4,4′-diaminodicyclohexylmethane, 1,4-diaminocyclohexane, aminoethyl ethanolamine, hydrazine, hydrazine hydrate or triamines such as diethylenetriamine or 1,8-diamino-4-a ino ethyloctane. The amines can also be used in blocked form, e.g., in the form of the corresponding ketimines (see for example CA-A 1 129 128), ketazines (cf., e.g., U.S. Pat. No. 4,269,748) or amine salts (see U.S. Pat. No. 4,292,226). Oxazolidines as well, as used for example in U.S. Pat. No. 4,192,937, represent blocked polyamines which can be used for the preparation of the polyurethanes of the invention, for chain extension of the prepolymers. Where blocked polyamines of this kind are used, they are generally mixed with the prepolymers in the absence of water and this mixture is then mixed with the dispersion water or with a portion of the dispersion water, so that the corresponding polyamines are liberated by hydrolysis. It is preferred to use mixtures of diamines and triamines, more preferably mixtures of isophoronediamine (I PDA) and diethylenetriamine (DETA).

The polyurethanes comprise preferably 1 to 30 mol %, more preferably 4 to 25 mol %, based on the total amount of components (b) and (d), of a polyamine having at least 2 isocyanate-reactive amino groups as monomers (d).

For the same purpose it is also possible to use, as monomers (d), isocyanates having a functionality of more than two. Examples of standard commercial compounds are the isocyanurate or the biuret of hexamethylene diisocyanate.

Monomers (e), which are used optionally, are monoisocyanates, monoalcohols, and mono primary and -secondary amines. Their fraction is generally not more than 10 mol %, based on the total molar amount of the monomers. These monofunctional compounds customarily carry further functional groups such as olefinic groups or carbonyl groups and serve to introduce into the polyurethane functional groups, which facilitate the dispersing and/or the crosslinking or further polymer-analogous reaction of the polyurethane. Monomers suitable for this purpose include those such as isopropenyl-a,a′-dimethylbenzyl isocyanate (TMI) and esters of acrylic or methacrylic acid such as hydroxyethyl acrylate or hydroxyethyl methacrylate.

The polyurethane of the aqueous polyurethane dispersion having at least a first glass transition temperature T_{g1} and a second glass transition temperature T_{g2} can be prepared from
a) at least one organic diisocyanate, selected from diisocyanates of the formula X(NCO)₂, where X is a noncyclic aliphatic hydrocarbon radical having 4 to 15 carbon atoms, a cycloaliphatic hydrocarbon radical having 6 to 15 carbon atoms, an aromatic hydrocarbon radical having 6 to 15 carbon atoms, or an araliphatic hydrocarbon radical having 7 to 15 carbon atoms, wherein the amount of aromatic diisocyanates is less than 60 mol-%, based on the sum of all organic diisocyanates a);
b1) at least one dihydroxy compound having a molecular weight of 500 g/mol to 5000 g/mol and selected from the group consisting of polyesterdiols, polyetherols and polytetrahydrofuran;
b2) at least one dihydroxy compound selected from the group consisting of branched or unbranched acyclic diols having 2 to 8 C atoms, and cyclic diols having 3 to 8 C atoms, the at least dihydroxy compound having preferably a molecular weight from 62 g/mol to 200 g/mol.
c) at least one compound having at least one group reactive toward isocyanate groups, and additionally carrying at least one ionic group or one group which can be converted into an ionic group, wherein the compounds c) preferably contain a group selected from carboxylate groups and sulfonate groups,
d) optionally further compounds different from a) to c).

Preferred polyurethanes are synthesized from:
a) at least one monomeric diisocyanate,
b) the at least diols b1) and b2),
c) at least one monomer, different from the monomers (a) and (b), having at least one isocyanate group or at least one group reactive toward isocyanate groups, and additionally carrying at least one hydrophilic group or potentially hydrophilic group,
d) optionally at least one further compound, different from the monomers (a) to (c), having at least two reactive groups selected from alcoholic hydroxyl groups, primary or secondary amino groups or isocyanate groups, and
e) optionally at least one monofunctional compound, different from the monomers (a) to (d), having a reactive group which is an alcoholic hydroxyl group, a primary or secondary amino group or an isocyanate group.

Preferably, the polyurethane dispersion is an anionic polyurethane dispersion made with low amount of aromatic diisocyanates or no aromatic diisocyanates, e.g. less than 60 mol %, based on the sum of all organic diisocyanates a). The anionic groups of the anionic polyurethane are preferably selected from carboxylate groups and sulfonate groups. The same applies to the polyurethane comprised in the at least partly coated particle and shaped body according to the present invention.

Component b) is composed preferably of
b1) 10 to 90 mol %, based on the total amount of component b), of diols b1),
b2) 10 to 90 mol %, based on the total amount of component b), of diols b2).

The molar ratio of the diols b1) to the monomers b2) is more preferably 1:5 to 5:1, more preferably 1:2 to 2:1.

Particular mention may be made as monomers (a) of diisocyanates X(NCO)₂, where X is a noncyclic aliphatic hydrocarbon radical having 4 to 15 carbon atoms, a cycloaliphatic or aromatic hydrocarbon radical having 6 to 15 carbon atoms, or an araliphatic hydrocarbon radical having 7 to 15 carbon atoms. Examples of such diisocyanates include tetramethylene diisocyanate, hexamethylene diisocyanate (HDI), dodecamethylene diisocyanate, 1,4-diiso-cyanatocyclohexane, 1-isocyanato-3,5,5-trimethyl-3-isocyanatomethyl-cyclohexane (IPDI), 2,2-bis(4-isocyanatocyclohexyl)-propane, trimethylhexane diisocyanate, 1,4-diisocyanatobenzene, 2,4-diisocyanatotoluene, 2,6-diisocyanatotoluene (TDI), 4,4′-diisocyanato-diphenylmethane, 2,4′-diisocyanatodiphenylmethane, p-xylylene diisocyanate, tetramethylxylylene diisocyanate (TMXDI), the isomers of bis(4-isocyanatocyclohexyl)methane (HMDI) such as the trans/trans, the cis/cis, and the cis/trans isomers, and mixtures of these compounds. Diisocyanates of this kind are available commercially. With particular preference the diisocyanate is selected from the group consisting of hexamethylene diisocyanate, 1-isocyanato-3,5,5-trimethyl-3-isocyanatomethyl-cyclohexane, 2,6-diisocyanatotoluene, and tetramethylxylylene diisocyanate, or a mixture thereof. Particularly important mixtures of these isocyanates are the mixtures of the respective structural isomers of diisocyanatotoluene and diisocyanatodiphenylmethane; the mixture of 80 mol % 2,4-diisocyanatotoluene and 20 mol % 2,6-diisocyanatotoluene is particularly suitable. Also of particular advantage are the mixtures of aromatic isocyanates such as 2,4-diisocyanatotoluene and/or 2,6-diisocyanatotoluene with aliphatic or cycloaliphatic isocyanates such as hexa-methylene diisocyanate or IPDI, in which case the preferred molar mixing ratio of the aliphatic to the aromatic isocyanates is 1:9 to 9:1, more particularly 4:1 to 1:4. It is also preferred that only aliphatic isocyanates are used.

The diols (b1) may be polyester polyols, which are known, for example, from Ullmanns Enzyklopadie der technischen Chemie, 4th edition, volume 19, pp. 62 to 65. It is preferred to use polyester polyols which are obtained by reacting dihydric alcohols with dibasic carboxylic acids. Instead of the free polycarboxylic acids it is also possible to use the corresponding polycarboxylic anhydrides or corresponding polycarboxylic esters of lower alcohols or mixtures thereof to prepare the polyester polyols. The polycarboxylic acids can be aliphatic, cyclo aliphatic, araliphatic, aromatic or heterocyclic and can optionally be substituted, by halogen atoms for example, and/or unsaturated. Examples thereof include the following: suberic acid, azelaic acid, phthalic acid, isophthalic acid, phthalic anhydride, tetrahydrophthalic anhydride, hexahydrophthalic anhydride, tetrachlorophthalic anhydride, endomethylene tetrahydrophthalic anhydride, glutaric anhydride, maleic acid, maleic anhydride, fumaric acid, and dimeric fatty acids. Preferred dicarboxylic acids are those of the general formula HOOC—(CH₂)_{y}—COOH, where y is a number from 1 to 20, preferably an even number from 2 to 20, examples being succinic acid, adipic acid, sebacic acid, and dodecane dicarboxylic acid. Examples of suitable dihydric alcohols include ethylene glycol, propane-1,2-diol, propane-1,3-diol, butane-1,3-diol, butene-1, 4-diol, butyne-1,4-diol, pentane-1, 5-diol, neopentyl glycol, bis(hydroxymethyl) cyclohexanes such as 1,4-bis(hydroxymethyl)cyclohexane, 2-methylpropane-1,3-diol, methylpentanediols, and also diethylene glycol, triethylene glycol, tetraethylene glycol, polyethylene glycol, dipropylene glycol, polypropylene glycol, and dibutylene glycol and polybutylene glycols. To obtain crystallinity preferred alcohols are those of the general formula HO—(CH₂)ₓ—OH, where x is a number from 1 to 20, preferably an even number from 2 to 20. Examples of such alcohols are ethylene glycol, butane-1,4-diol, hexane-1,6-diol, octane-1, 8-diol, and dodecane-1,12-diol.

The diols (b1) may also be polytetrahydrofuran. Suitable polytetrahydrofurans can be prepared by cationic polymerization of tetrahydrofuran in the presence of acidic catalysts, such as sulfuric acid or fluorosulfuric acid, for example. Preparation processes of this kind are known to the skilled person.

The diols (b1) may also be polyether diols. Polyether diols are obtainable in particular by polymerizing ethylene oxide, propylene oxide, butylene oxide, tetrahydrofuran, styrene oxide or epichlorohydrin with itself, in the presence of BF3 for example, or by subjecting these compounds, optionally in a mixture or in succession, to addition reaction with starter components containing reactive hydrogen atoms, such as alcohols or amines, examples being water, ethylene glycol, propane-1,2-diol, propane-1,3-diol, 2,2-bis(4-hydroxyphenyl)propane, and aniline. Particular preference is given to polyether diols with a molecular weight of 500 to 5000, and in particular 600 to 4500.

The polyurethane of the aqueous polyurethane dispersion and comprised in the at least partly coated particle and shaped body according to the present invention has a K-value from higher than 50 and lower than 100, preferably, from 55 to 95.

The K value is a relative viscosity number, which is determined in analogy to DIN EN ISO 1628-1 2021 at 25° C. It comprises the flow rate of a 1 weight-% strength solution of the polyurethane in DMF, relative to the flow rate of pure DMF, and characterizes the average molecular weight of the polyurethane.

Within the field of polyurethane chemistry it is general knowledge how the molecular weight (and thus the K value) of polyurethanes can be adjusted by selecting the proportions of the mutually reactive monomers and also the arithmetic mean of the number of reactive functional groups per molecule. Components (a) to (e) and their respective molar amounts are normally chosen so that the ratio A:B, where
A) is the molar amount of isocyanate groups and
B) is the sum of the molar amount of the hydroxyl groups and the molar amount of the functional groups which are able to react with isocyanates in an addition reaction, is 0.5:1 to 2:1, preferably 0.8:1 to 1.5:1, more preferably 0.9:1 to 1.2:1. With very particular preference the ratio A:B is as close as possible to 1:1.

The monomers (a) to (e) employed carry on average usually 1.5 to 2.5, preferably 1.9 to 2.1, more preferably 2.0 isocyanate groups and/or functional groups which are able to react with isocyanates in an addition reaction. Very high K-values are achieved be using monomers (a) to (e) with functionalities >2.5 in small amounts or monomers which additionally carry crosslinking groups like carbodiimide, silane, aziridine etc.

The polyaddition of components (a) to (e) for preparing the polyurethane takes place preferably at reaction temperatures of up to 180° C., more preferably up to 150° C., for example from 20 to 180° C., preferably from 70 to 150° C., under atmospheric pressure or under autogenous pressure. The preparation of polyurethanes, and of aqueous polyurethane dispersions, is known to the skilled person. The polyaddition of the synthesis components for the preparation of the poly urethanes, can be catalyzed using organic or organometallic compounds. Suitable catalysts include dibutyltin dilaurate (DBTL), tin (II) octoate, tetrabutoxytitanium (TBOT), or diazabicyclo[2.2.2]octane. Other suitable catalysts are salts of cesium, especially cesium carboxylates such as, for example, the formate, acetate, propionate, hexanoate, or 2-ethylhexanoate of cesium. An aqueous polyurethane dispersion for the purposes of the present invention is a dispersion which has an aqueous solvent as a continuous phase. Suitable aqueous solvents are water and mixtures of water with water-miscible solvents, examples being alcohols, such as methanol, ethanol, n-propanol, isopropanol, n-butanol, sec-butanol, tert-butanol, n-hexanol and cyclohexanol; glycols, such as ethylene glycol, propylene glycol, and butylene glycol; the methyl or ethyl ethers of the dihydric alcohols, diethylene glycol, triethylene glycol, polyethylene glycols having number-average molecular weights of up to about 3000, glycerol and dioxane and also ketones, such as acetone in particular. Preferably the polyurethane dispersion is substantially free from organic solvents. By “substantially free from organic solvents” here is meant that the fraction of organic solvents is not more than 5% by weight, more preferably not more than 1% by weight, more particularly not more than 0.1% by weight, based on the total weight of the solvent.

Preferably the polyurethanes are prepared in the presence of at least one organic solvent. Preferred organic solvents for preparing the polyurethanes are ketones, such as acetone and methyl ethyl ketone, and also N-methylpyrrolidone. Acetone is used with particular preference. Where an at least partly water-miscible solvent is used for preparing the polyurethanes, the polyurethane dispersion of the invention may comprise, in addition to water, the organic solvent used for the preparation. It will be appreciated that the polyurethane dispersions of the invention can be prepared in the presence of at least one organic solvent which is subsequently replaced in whole or in part by water.

The polyurethane dispersions may be prepared for example by one of the following processes: According to the “acetone process”, an ionic polyurethane is prepared from the synthesis components in a solvent which is miscible with water and which boils below 100° C. under atmospheric pressure. Sufficient water is added to form a dispersion in which water represents the coherent phase. The “prepolymer mixing process” differs from the acetone process in that, rather than a fully reacted (potentially) ionic polyurethane, a prepolymer is first of all prepared that carries isocyanate groups. The components in this case are selected such that the as-defined ratio A:B is greater than 1.0 and up to 3, preferably from 1.05 to 1.5. The prepolymer is first dispersed in water and then optionally crosslinked by reaction of the isocyanate groups with amines which carry more than 2 isocyanate-reactive amino groups, or chain extended by reaction of the isocyanate groups with amines which carry 2 isocyanate-reactive amino groups. Chain extension also takes place when no amine is added. In that case, isocyanate groups are hydrolyzed to amino groups, which are consumed by reaction with remaining isocyanate groups in the prepolymers, with chain extension. Customarily, if a solvent has also been used during the preparation of the polyurethane, the major portion of the solvent is removed from the dispersion, by means of distillation under reduced pressure, for example, The dispersions preferably have a solvent content of less than 10 weight % and with particular preference are free from solvents. Solvents are understood to mean organic solvents.

Preferably, the polyurethane of the aqueous polyurethane dispersion and comprised in the at least partly coated particle and shaped body according to the present invention is prepared from
a) at least one organic diisocyanate, selected from diisocyanates of the formula X(NCO)₂, where X is a noncyclic aliphatic hydrocarbon radical having 4 to 15 carbon atoms, a cycloaliphatic hydrocarbon radical having 6 to 15 carbon atoms, an aromatic hydrocarbon radical having 6 to 15 carbon atoms, or an araliphatic hydrocarbon radical having 7 to 15 carbon atoms, wherein the amount of aromatic diisocyanates is less than 60 mol-%, based on the sum of all organic diisocyanates a),
b) at least one dihydroxy compound selected from the group consisting of polyesterdiols and polytetrahydrofuran,
c) at least one compound having at least one group reactive toward isocyanate groups, and additionally carrying at least one ionic group or one group which can be converted into an ionic group, wherein the compounds c) preferably contain a group selected from carboxylate groups and sulfonate groups,
d) optionally further compounds different from a) to c).

In the first step a₁) of the process of the present invention, the particles are brought into contact with an aqueous polyurethane dispersion, the polyurethane having a K-value according to DIN EN ISO 1628-1 2021 in the range from higher than 50 to lower than 100, preferably from 55 to 95, resulting in at least partly coated particles.

Preferably, in step a₁) the bringing into contact is realized by mixing the foamed beads with the dispersion using kitchen or cement mixers or spraying, like mixing with a Vollrath mixer or spray drying. The amount of liquid/suspension relative to the product weight may be in the range of from 1 ml/kg/min to 1000 ml/g/min. The size of droplets may vary from 1 mm to 1000 mm in diameter. Suitable nozzles would be hollow cone nozzles, full cone nozzles or flat jet nozzles, as well as spray discs that produce droplets through rotational movement and centrifugal force. A suitable mixer that can be used is an EMT 30 L. EMT L 30 is a discontinuous paddle mixer. It is suitable for mixing, agglomeration and coating experiments. It consists of a rigid vessel with rotatable mixing tools. Depending on the field of application there are various available installation possibilities nozzles. The mixer is heatable due to a double jacket. The rotation speed is adjustable via a mechanical variator. Melt containers and pressure vessels are used for the addition of liquids.

In general, common methods for coating, like spray coating, e.g. as described in EP 0 009 727 A1, can be used. In a preferred embodiment of coating, the particle are spray-coated keeping them in motion via blowing them with e.g. air or mixtures of different gases.

The at least partly coated particles are coated in an amount of from 0.1 wt.-% to 40 wt.-%, preferably from 5 wt.-% to 25 wt.-% based on the total weight of particle and coating. Preferably, the at least partly coated particles are coated in an amount of at least 90%, preferably at least 95%, more preferably at least 99%, more preferably fully coated based on the total surface of the particle.

The step a₂) refers to the drying the coated particles. In principle, all suitable methods are possible, like convective drying, contact drying, infrared drying and also microwave technology.

In the case of contact drying, the temperature difference between the product and the wall in should be limited to 1-100 K, in the case of convective drying the gas composition can be N₂ or air. The gas quantity is preferably 1-1000 litres/min per 1 kg product and the product temperature in the mixer should be between 1° C. and 100° C., preferably 10° C. to 60° C.

Preferably, during step a₂) the at least partly coated particles are kept moving. This can prevent agglomeration of the particles.

Preferably, after step a₁) and before step a₂) the particles are separated from each other. This can be achieved, e.g. by using a vibrating belt or the like. Also this option prevents agglomeration of the particles.

Another aspect of the present invention is a process for the preparation of a shaped body comprising the steps of
b1) coating of particles of an expanded thermoplastic elastomer according to the process of the present invention.
b2) shaping the particles obtained from step b1).

Preferably, the shaping in step b2) is carried out by steam-less thermo-pressing.

Preferably, the thermo-pressing (also called hot press or heat press) is carried out at a temperature of from 60° C. to 160° C., more preferably from 80° C. to 160° C., even more preferably from 90° C. to 140° C., even more preferably from 90° C. to 130° C.

Preferably, after shaping by thermo-pressing the resulting shaped bodies are cooled down to room temperature, which can improve mechanical properties.

In one embodiment of the invention, the molding (shaping) process can be carried out by using an electro-magnetic field in order to generate completely or partly the required heat. The electro-magnetic field is preferably in the range of 30 kHz to 1 GHz (corresponding to radio frequency (RF) and microwave molding) and more preferably from 30 kHz to 300 MHZ (corresponding to RF molding).

Thus, in a preferred embodiment the shaping is carried out by heat, wherein the heat is produced partly or completely by an electro-magnetic field in the range of 30 kHz to 1 GHZ, preferably in the radio frequency range (30 kHz to 300 MHZ).

Shaping by energetic radiation is generally carried out in the microwave-frequency range of 300 MHz-300 GHz or in the radio-frequency range of 30 kHz-300 MHz. Microwaves are preferably applied in the frequency range between 0.5 and 100 GHZ, especially preferably in the range between 0.8 and 10 GHz and irradiation times between 0.1 and 15 min are used. Radio waves are preferably applied in the frequency range between 500 kHz and 100 MHz, especially preferably in the range between 1 MHz and 80 MHz and irradiation times between 0.1 and 30 min are used.

Preferably, the shaped body is a composite material of the particles with other materials, like textile, leather, a thermoplastic film or parts containing metals.

Another aspect of the present invention relates to a method for disposing a shaped body comprising the steps of
c₁) preparing a shaped body according to the process of the present invention;
c₂) disassembling the particles by subjecting the shaped body to an alkaline aqueous fluid that may comprise surfactants.

The at least partly coated particles according to the present invention can be used pure, as a mixture of different particles and/or other materials to obtain 3D parts for industrial, consumer, transportation, and construction-application used solely or as a component for sealing, insolation of e.g. houses, pipelines or gas-tanks, part of a shoe, shoe midsole, shoe insert, shoe combi sole, bicycle seats, bicycle tires, dampening element, shock protection, sound and vibration dampers, decoration, furniture, upholstery, mattress, yoga matts, underlayment, railway pads, handles, protective sheet, packaging, fall protection, automotive interior and exterior, headliner, arm rest, door lining, seats, battery housing, sport equipment, balls, tennis-racket, base-ball club, treadmill, toys, flooring, running tracks, artificial turf, play-grounds, sport halls, and sidewalks.

### EXAMPLES

Viscosity was measured according to DIN EN ISO 3219-2:2021 at 23° C. and a shear rate of 250 s⁻¹.

The dispersions were dried in a mold at 40° C. for 3 days and then at 23° C. for 7 days. Thermal properties were measured by differential scanning calorimetry.

The glass-transition temperature was determined according to DIN EN ISO 11357-2 (2014), as so-called midpoint temperature. The glass transition temperature of the polymer in the polymer dispersion is the glass transition temperature obtained when evaluating the second heating curve (heating rate 20° C./min). The melting-points and enthalpy of fusion are determined according to DIN ISO 11357-3 (2018) (melting point=peak temperature) by heating with 20 K/min after cooling to −80° C.; while enthalpy of fusion of the second run (Delta H2) is calculated from the area of second melting only;
a) from a film at its untreated state (drying see above)→Tm1, Delta H1
b) after heating the polyurethane films to 130° C., cooling with 20 K/min to −80° C.; reheating with 20 k/min->Tₘ2 delta H2

### Example 1: PUD According to Example 1 of WO 2012/13506 A1

The example was repeated: s.c. 40%. K-value: 55 Viscosity: 48 mPas Tg: −46° C.

| Tm1 | DELTA H 1 | Tm2 | DELTA H 2 |
|---|---|---|---|
| 47° C. | 47 J/g | 42.6 | 34 J/g |

### Example 2

676 g of a polyesterdiol from Adipic acid and 1,4 butanediol (OH number 45) were reacted with 0.11 g titaniumtetrabutylate, 40 g IPDI, 0.77 g NCO-terminated polycarbodiimid (Elastostab H02, BASF) at 60° C. in 153 g dry acetone for 60 min. Then, 37.8 g HDI was added and the temperature raised to 74° C. The reaction was continued until the NCO-value was lower than 1.25%. The mixture was diluted with 539 g acetone and cooled to 35-40° C. Then 22.4 g of Aminoethyl aminoethansulfonate sodium salt (50% in water) diluted with 22 g dem. water was added in 3 min, followed by 4.6 g Isophoronediamine diluted in 23 g dem. water also in 3 min. Before dispergation 38.7 g of a 20% aq. solution of Lutensol AT18 (BASF) was added as, followed by dispergation with 463 g demineralized water in 15 min, Immediately after the water feed, 4 g of N-(2-aminoethyl) ethanolamine in 30 g water was added in 15 min., with additional amount of 200 g demineralized water. The acetone was removed by vacuum distillation with the help of two drops of defoamer (modified polyalkylene glycol, FoamStar PB 2724, BASF) and the solids content adjusted to 50%.

K-value: 60 Viscosity: 169 mPas Tg: −55° C.

| Tm1 | DELTA H 1 | Tm2 | DELTA H 2 |
|---|---|---|---|
| 51° C. | 54 J/g | 46° C. | 32 J/g |

### Example 3

541 g of a polyesterdiol from Adipic acid, 1,6-hexanediol and 1,4-butanediol (OH number 56) were reacted with 0.11 g titaniumtetrabutylate, 40 g IPDI, 0.9 g NCO-terminated polycarbodiimid (Elastostab H02, BASF) at 60° C. in 153 g dry acetone for 60 min. Then 37.8 g HDI was added and the temperature raised to 74° C. The reaction was continued until the NCO-value was lower than 1.47%. The mixture was diluted with 539 g acetone and cooled to 35-40° C. Then 21.9 g of aminoethyl aminoethansulfonate sodium salt (50% in water) diluted with 22 g demineralized water was added in 3 min, followed by 4.6 g Isophoronediamine diluted in 23 g dem. water also in 3 min. Before dispergation 31.8 g of a 20% aq. solution of Lutensol AT18 (BASF) was added as, followed by dispergation with 361 g demineralized water in 15 min. Immediately after the water feed, 4 g of N-(2-aminoethyl) ethanolamine in 30 g water was added in 15 min. with additional amount of 200 g demineralized water. The acetone was removed by vacuum distillation with the help of two drops of defoamer (modified polyalkylene glycol, FoamStar PB 2724, BASF) and the solids content adjusted to 50%.

K-Value: 66.5 Viscosity: 51 mPas Tg: −57° C.

| Tm1 | DELTA H 1 | Tm2 | DELTA H 2 |
|---|---|---|---|
| 24° C. | 24 J/g | 24° C. | 21 J/g |

### Example 4

748 g of a polyesterdiol from adipic acid and 1,4 butanediol (OH number 45) was reacted with 13.5 g 1,4-Butanediol and 49.8 g Toluylenediisocyanate (80/20 mixture of isomers) with the help of 0.2 g Tetrabutyl titanate as catalyst in 309 g dry acetone at 65° C. until a NCO-value of 0.2% was reached, Then 48 g Hexamethylenediisocyanate was added followed by a rinse with 58 g dry acetone. The reaction was continued until the NCO-value was 0.95%. The mixture was diluted with 684 g acetone and cooled to 40° C.

The chain extension was done with 43.4 g of a 50% s.c. aqueous solution of Aminoethyl-aminoethansulfonate sodium salt in 10 min. Then 4.4 g of Lutensol TO5 (Ethoxylated, iso-C13 alcohol, BASF) dissolved in 12 g water was added followed by 726 g of deionized water. The acetone was removed by vacuum distillation, two portions (2×0.1 g) of defoamer Foamstar PB 2724 (modified polyalkylene glycol) had to be added during distillation to control the foam. Solids content was adjusted to 45%.

K-value 56 Viscosity: 19 mPas Tg: −54° C.

| Tm1 | DELTA H 1 | Tm2 | DELTA H 2 |
|---|---|---|---|
| 54.5° C. | 46 J/g | 43.5° C. | 32 J/g |

### Example 5

745 g (0.30 mol) of a polyesterdiol with an OH number of 45.2 (based on 1,4-butanediol/adipic acid), 13.4 g (0.10 mol) of dimethylolpropionic acid, 1.0 g of tetrabutyl orthotitanate (10% form), and 100 g of acetone were introduced as an initial charge, admixed at 60° C. with 112.3 g (0.505 mol) of isophorone diisocyanate, and stirred at 90° C. for 4 hours. Then, in succession, 900 g of acetone, 20.25 g of triisopropanolamine (0.09 mol), 5 g of carbodiimide (polymer based on 1,3-bis(1-isocyanato-1-methylethyl)benzene, isocyanate end groups) in 5 g of acetone (0.005 mol), 0.97 g of aminopropyl trimethoxysilane (0.005 mol), 31.35 g of aminoethyl aminoethane sulfonic acid Natrium salt (0.075 mol), and 40 g of water were metered in and the reaction mixture was stirred for a further 20 minutes. It was dispersed with 1300 g of water; afterwards the acetone was distilled off under reduced pressure and the solids content was adjusted to approximately 40%.

K value: 94 Viscosity: 120 mPas Tg: −53° C.

| Tm1 | DELTA H 1 | Tm2 | DELTA H 2 |
|---|---|---|---|
| 45.5° C. | 39 J/g | 44.4° C. | 31.3 J/g |

### Example 6

726 g of a polyesterdiol from Adipic acid and 1,4 butanediol (OH number 45) was reacted with 8.05 g dimethylolpropionic acid (DMPA) and 67.3 g Hexamethylenediisocyanate in 80 g water-free acetone at 90° C. to a NCO-content of 0.52-0.47%. The mixture was then diluted with 600 g of acetone and cooled to 35° C. The mixture was neutralized with 5.8 g Triethylamine and chain stopped with 3.15 g Diethanolamine in 25 g deionized water. After 10 min, the mixture was dispersed using 785 g of deionized water and stabilized by adding 40 g of a 20% solution of Lutensol AT 18 (ethoxylated C16/C18 alcohol, BASF). The acetone was removed by distillation in vacuo, and solids content was adjusted to 50%.

K-value: 55 Viscosity: 63 mPas Tg: −53° C.

| Tm1 | DELTA H 1 | Tm2 | DELTA H 2 |
|---|---|---|---|
| 56° C. | 63 J/g | 45° C.; 52° C. | 60 J/g |

79.5 g of the dispersion was formulated with 0.1 g Lumiten I-SC (Solution of sodium sulphosuccinate and isotridecanol ethoxylated in water, BASF) and 6 g Aqualink U (Dispersion of blocked TDI dimer, Aquaspersion co., UK) to give a latent reactive dispersion.

### Example 7

563 g of a polyesterdiol from Adipic acid and 1,4 butanediol (OH number 45), 0.17 g Borchikat 315 (Tin-free catalyst, Bismuth Neodecanoate, Borchers) was reacted with 67.9 g IPDI at 60° C.-65° C. in 90 g dry acetone until a NCO-value of 0.9% was reached. The mixture was diluted with 630 g acetone and cooled to 50° C. Then 21.8 g of Aminoethyl-aminoethane-sulfonate sodium salt (50% in water) diluted with 22 g demineralized water was added in 3 min. After 10 min. the dispersing was continued with 927 g deionized water. The acetone was removed by vacuum distillation with the help of two drops of defoamer (modified polyalkylene glycol, FoamStar PB 2724, BASF) and the solids content adjusted to 40%.

K-value 60 Viscosity: 121 mPas Tg: −53° C.

| Tm1 | DELTA H 1 | Tm2 | DELTA H 2 |
|---|---|---|---|
| 56.5° C. | 46 J/g | 40.3° C. | 32 J/g |

### Example 8

563 g of a polyesterdiol from Adipic acid and 1,4 butanediol (OH number 45) were reacted with 0.08 g Borchikat 315 (Tin-free catalyst, Bismuth Neodecanoate, Borchers), 51.4 g HDI, at 60° C.-65° C. in 90 g dry acetone until a NCO-value of 0.96% was reached. The mixture was diluted with 630 g acetone and cooled to 50° C. Then 21.8 g of Aminoethyl-aminoethane-sulfonate sodium salt (50% in water) diluted with 22 g demineralized water was added in 3 min. After 10 min the dispersing was continued with 907 g deionized water. The acetone was removed by vacuum distillation with the help of two drops of defoamer (modified polyalkylene glycol, FoamStar PB 2724, BASF) and the solids content adjusted to 40%.

K-value 65 Viscosity 50 mPas Tg: −54° C.

| Tm1 | DELTA H 1 | Tm2 | DELTA H 2 |
|---|---|---|---|
| 56° C. | 56 J/g | 49° C. | 51 J/g |

### Example 9

332 g of a polyesterdiol from Adipic acid and 1,4 butanediol (OH number 45) and 271 g of poly-THF 2000 (OH number=56 mg KOH/g) were reacted with 27.8 g IPDI and 41.4 g HDI at 100° C. in 60 g dry acetone for 6 hours. The mixture was diluted with 804 g acetone and cooled to 40° C. The chains were stopped by adding a mixture of 3.55 g Diethanolamine, 0.82 g N-(2-aminoethyl) ethanolamine and 16 demineralized water. Then 18.7 g of Aminoethyl-aminoethane-sulfonate sodium salt (50% in water) diluted with 17 g demineralized water was added in 3 min. After 10 min. the dispersing was continued in 30 min. with 657 g deionized water. The acetone was removed by vacuum distillation with the help of two drops of defoamer (modified polyalkylene glycol, FoamStar PB 2724, BASF). To stabilize the dispersion, 68.6 g of a 20% solution of Lutensol AT 18 (ethoxylated C16/C18 alcohol, BASF) was added and the solids content adjusted to 48%.

K-Value 57 Viscosity: 210 mPas Tg: −57° C.

| Tm1 | DELTA H 1 | Tm2 | DELTA H 2 |
|---|---|---|---|
| 18.4° C.; 53° C. | 51 J/g | 18.1° C., 46° C. | 39 J/g |

### Example 10

543 g of a polyesterdiol from Adipic acid, 1,6 Hexanediol and 1,4 butanediol (OH number 56) was reacted with 27.12 g IPDI and 40.4 g HDI at 95° C. in 60 g dry acetone until a NCO-value between 1.14%-1.0% was reached. The mixture was diluted with 804 g acetone and cooled to 40° C. The chains were stopped by adding a mixture of 3.55 g Diethanolamine, 0.83 g N-(2-aminoethyl) ethanolamine and 16 demineralized water. Then 14.1 g of Aminoethyl-aminoethane-sulfonate sodium salt (50% in water) diluted with 17 g dem. water was added in 3 min. After 10 min. the dispersing was continued in 30 min. with 594 g deionized water. The acetone was removed by vacuum distillation with the help of two drops of defoamer (modified polyalkylene glycol, FoamStar PB 2724, BASF). To stabilize the dispersion, 62 g of a 20% solution of Lutensol AT 18 (ethoxylated C16/C18 alcohol, BASF) was added and the solids content adjusted to 50%.

K-value: 57 Viscosity: 59 mPas Tg: −57° C.

| Tm1 | DELTA H 1 | Tm2 | DELTA H 2 |
|---|---|---|---|
| 27.8° C. 42° C. | 42 J/g | 27° C. | 32 J/g |

### Example 11

1039 g of a polyesterdiol from Adipic acid and Isophthalic acid (molar 1:1) and 1,6 Hexanediol (molecular weight 2000 g/mol), 104.6 g of Dimethylolpropionic acid (DMPA), 186.8 g Butanediol-1,4 were reacted with 900 g IPDI, in 530 g dry acetone in a pressurized reactor; starting at 50° C., increasing the temperature in 30 min to 90° C., then at 90° C. for 8 h at 2.9 bar. The mixture was diluted with 1852 g acetone and cooled to 40° C. and expanded to atmospheric pressure. The NCO-value was determined to 1.2%. Then 10.2 g of Isophoronediamine were added in a shot, followed by 81 g Diethylethano-lamine (neutralization agent) in 5 min. After 5 min stirring, the dispersion step was continued with 3567 g deionized water in 37 min at 30° C., followed by an addition of 19.8 Diethylenetriamine in 340 g deionized water in 30 min. The acetone was removed by vacuum distillation with the help of 0.23 g of defoamer (FoamStar PB 2724, BASF) and the solids content was 37.4%.

Dispersion Ex11

| K-value | 63 | |
|---|---|---|
| Viscosity | 31 | mPas |
| Tg1 | −20° | C. |
| Tg2 | 69° | C. |

### Example EX12

1024 g of a polyesterdiol from Adipic acid and Isophthalic acid (molar 1:1) and 1,6 Hexanediol (molecular weight 2000 g/mol), 104.6 g of Dimethylolpropionic acid (DMPA), 187 g Butanediol-1,4 and 72.8 g of a side chain polyethyleneglycol, Ymer N 120 (Perstorp) were reacted with 686.3 g IPDI in 550 g dry acetone in a pressurized reactor; starting at 55° C., feeding IPDI and increasing the temperature in 30 min to 75° C., then at 75° C. for 1.5 h at 2.4 bar. Then the second portion of 228.8 g IPDI and 18 g acetone were added and the reaction continued until the NCO-value is 2.2%. The mixture was diluted with 1574 g acetone and cooled to 40° C. and expanded to atmospheric pressure. The NCO-value was determined to 1.39%. Then the mixture was further diluted with 366 g acetone and 10.5 g of Isophoronediamine were added in a shot, followed by 82.2 g Diethylethanolamine (neutralizing agent) in 5 min. After 10 min stirring, the dispersion step was continued with 3294 g deionized water in 37 min at 39° C., followed by an addition of 19.8 Diethylenetriamine in 346 g deionized water in 30 min. The acetone was removed by vacuum distillation with the help of 0.58 g of defoamer (FoamStar PB 2724, BASF) and the solids content was 37%.

Dispersion Ex12

| K-value | 57 | |
|---|---|---|
| Viscosity | 173 | mPas |
| Tg1 | −22° | C. |
| Tg2 | 75° | C. |

### Comparative Example C1: Amorphous Dispersion

706 g of Polypropylene-oxide-diol (OH number=57.2 mg KOH/g) and 57.9 g dimethylolpropionic acid (DMPA) were reacted at 110° C. in 63 g water-free acetone with 137.9 g Toluylenediisocyanate (80/20 mixture of isomers) to a NCO-content <0.1%. The mixture was then diluted with 720 g of acetone and cooled to 25° C. The mixture was neutralized with 48.9 g of an aqueous NaOH solution (8 wt %) and the mixture was dispersed using 710 g of deionized water. The acetone was removed by distillation in vacuo, with the help of 3 drops of defoamer Foam Star PB2724 (modified polyalkylene glycol, BASF), and solids content is adjusted to 50%.

K-value 43; no melting point or crystalline parts could be detected

### Comparative Example C2: Amorphous Dispersion

801.4 g of Polypropylene-oxide-diol (OH number=56 mg KOH/g) and 64.4 g dimethylolpropionic acid (DMPA) were reacted at 100-110° C. in 100 g water-free acetone with 153.3 g Toluylenediisocyanate (80/20 mixture of isomers) to a NCO-content <0.1%. The mixture was then diluted with 800 g of acetone and cooled to 50° C. The mixture was neutralized with 19.4 g Triethylamine and the mixture was dispersed using 1580 g of deionized water. The acetone was removed by distillation in vacuo, and solids content is adjusted to 40%.

K-value 43, no melting point or crystalline parts could be detected

### Example 13: Coated e-TPU Beads by Using the Vollrath Dissolver

The polyurethane dispersion described in example 2 was mixed with E-TPU beads (particles), made according to WO2013/153190 A1, example 1 (Infinergy 230 based on Diisocyanate 4, BDO, and Polyol 1, company BASF SE) with a Vollrath dissolver for 60 second at room temperature. Later the beads were let drying at RT on a Teflon foil, keeping attention to isolate them from each other. After a time of around 10 minutes the beads were collected. The beads are tack-free and storage stable.

Different coating amounts were realized. 5% to 20% w/w dispersion to the beads.

E.g. 5 g of coating were mixed with 95 g of E-TPU bead for obtaining sample 1 (coating with 5% dispersion)
Sample 1: E-TPU beads coated with 5% dispersion
Sample 2: E-TPU beads coated with 10% dispersion
Sample 3: E-TPU beads coated with 15% dispersion
Sample 4: E-TPU beads coated with 20% dispersion

### Example 14: Coated e-TPU Beads by Using a Kitchen Mixer

The polyurethane dispersion, described in example 2, were mixed with E-TPU beads, made according to WO2013/153190 A1, example 1, having a bulk density 130 g/l and a particle weight of 27 mg (Infinergy 230 based on Diisocyanate 4, BDO, and Polyol 1, company BASF SE) with the help of a kitchen mixer (Bosch) equipped with a dough hook. The beads were mixed until the water was evaporated. For 100 g of product around 15 minutes until drying of the particles. The process leads to coated beads, tack-free and storage stable.

### Example 15: Coated e-TPU Beads by Using a Kitchen Mixer

The polyurethane dispersion, described in example 11, was mixed with E-TPU beads (particles), made according to WO2013/153190 A1, example 1 (Infinergy 230 based on Diisocyanate 4, BDO, and Polyol 1, company BASF SE) with a Vollrath dissolver for 60 second at room temperature. Later the beads were let drying at RT on a Teflon foil, keeping attention to isolate them from each other. After a time of around 10 minutes the beads were collected. The beads are tack-free and storage stable.

Different coating amounts were realized. 5% to 20% w/w dispersion to the beads.

E.g. 5 g of coating were mixed with 95 g of E-TPU bead for obtaining sample 1 (coating with 5% dispersion)
Sample 1: E-TPU beads coated with 5% dispersion
Sample 2: E-TPU beads coated with 10% dispersion
Sample 3: E-TPU beads coated with 15% dispersion
Sample 4: E-TPU beads coated with 20% dispersion

### Example 16: Coated e-TPU Beads by Using a Cement Mixer, Equipped with a Sieve Drum

2.75 kg of E-TPU beads made accordingly to WO2013/153190 A1, example 1, having a bulk density 130 g/l and a particle weight of 27 mg (Infinergy 230 based on Diisocyanate 4, BDO, and Polyol 1, company BASF SE) were placed in a cement mixer of the company Scheppach, model mix 140, which was equipped with a sieve drum. 481 g of dispersion of example 2 including 1% blue dye were slowly added to the cement mixer, under rotation. Within 90 seconds the beads were completely coated. The beads were then allowed to reach the sieve drum, which allowed separation of coated single beads and collection on the underneath Teflon belt. Within 10 minutes after coating the beads were tack free and could be collected and stored.

### Example 17: Coated Beads by Using a Spraying Dryer Equipment

1.4 kg of E-TPU beads (made accordingly to WO2013/153190 A1, example 1, having a bulk density 130 g/l and a particle weight of 27 mg Infinergy 230 based on Diisocyanate 4, BDO, and Polyol 1, company BASF SE) were placed in a 30-liter paddle mixer of the company EMT GmbH (year of manufacturing was 2013), where it was mixed with Becker blades at 100 rpm. 150 g of dispersion, described in example 2, was pumped via a gear pump at 3 bar to the nozzle of a diameter of 1.0 mm (manufacturer Spraying Systems), where it was sprayed on the moving E-TPU beads. The throughput was controlled at a flowrate of 75 g/min. The E-TPU beads were mixed while coated for 2 minutes at 100 rpm at 20° C. After the E-TPU-beads had been coated, 1.0 kg/h nitrogen at 20° C. was flushed into the mixer chamber via a separate tube of 4 mm inner-diameter to increase the drying intensity by convective drying.

After 7 hours of drying the pourable E-TPU beads were filled into plastic bags via the flap at the bottom of the mixer at constant mixing speed of 100 rpm.

### Example 18: Hot Press Experiments for the Realization of 3D Parts with Coated Beads

65 g of coated beads according to experiment 13 (sample 3) were placed in a preheated mold of dimension (16.3×9.6×3.3) cm³ (length, bright, depth), which was previously sprayed with Indrosil 2000 as silicone based release agent. The filled mold was covered with a mold lid (also sprayed with Indrosil 2000), which allows a compression/compaction of 50%. The time in the heated press and the residual time for cooling down the 3 D parts prior to demolding are summarized in the following table.

Moreover, the tensile strength and the elongation measured according to ASTM D 5035:2011, where instead of fabric strips (150×25.4×1.6) mm3 e-TPU strips were used, the rebound measured according to DIN 53512:2000-4 and the density of the obtained 3 D parts measured according to DIN EN ISO 845:2009-10, are as well reported below.

As a reference, 65 g of E-TPU beads according to WO2013/153190 A1, example 1, having a bulk density 130 g/l and a particle weight of 27 mg were placed in a preheated mold of dimension (16.3×9.6×3.3) cm³ (length, bright, depth)). The filled mold was covered with a mold lid, which allows a compression/compaction of 50%. This results in a plate with the following dimensions: (16×9.5×1.6) cm³—The hot press molded 3 D parts obtainable be not coated E-TPU beads are reported respectively.

| | | | Heating | | Tensile | | | |
|---|---|---|---|---|---|---|---|---|
| Experiment | Dispersion | Temperature | Time | Cooling | strength | Elongation | Rebound | Density |
| Nr. | of example 2 | [° C.] | [min] | [min] | [MPa] | [%] | [%] | [g/cm³] |
| 18-1 | 15% | 140 | 10 | 5 | 1.13 | 239 | 66 | 0.26 |
| C18-2 | 0% | 140 | 10 | 5 | 0.7 | 100 | 73 | 0.29 |
| 18-3 | 15% | 130 | 10 | 5 | 1.09 | 196 | 68 | 0.27 |
| C18-4 | 0% | 130 | 10 | 5 | 0.31 | 31 | 73 | 0.29 |
| 18-5 | 15% | 120 | 10 | 5 | 0.95 | 168 | 67 | 0.28 |
| C18-6 | 0% | 120 | 10 | 5 | 0.15 | 18 | 73 | 0.27 |
| 18-7 | 15% | 110 | 10 | 5 | 0.73 | 126 | 68 | 0.27 |
| C18-8 | 0% | 110 | 10 | 5 | 0.06 | 8 | 72 | 0.25 |

### Example 19

65 g of coated beads according to experiment 15 (sample 1) were placed in a preheated mold of dimension (16.3×9.6×3.3) cm³ (length, bright, depth), which was previously sprayed with Indrosil 2000 as silicone based release agent. The filled mold was covered with a mold lid (also sprayed with Indrosil 2000), which allows a compression/compaction of 50%. The time in the heated press and the residual time for cooling down the 3 D parts prior to demolding are summarized in the following table.

Moreover, the tensile strength and the elongation measured according to ASTM D 5035:2011, where instead of fabric strips (150×25.4×1.6) mm3 e-TPU strips were used, the rebound measured according to DIN 53512:2000-4 and the density of the obtained 3 D parts measured according to DIN EN ISO 845:2009-10, are as well reported below.

As a reference, 65 g of E-TPU beads according to WO2013/153190 A1, example 1, having a bulk density 130 g/l and a particle weight of 27 mg were placed in a preheated mold of dimension (16.3×9.6×3.3) cm³ (length, bright, depth)). The filled mold was covered with a mold lid, which allows a compression/compaction of 50%. This results in a plate with the following dimensions: (16×9.5×1.6) cm³—The hot press molded 3 D parts obtainable be not coated E-TPU beads are reported respectively.

| | Dispersion | | Heating | | Tensile | | | |
|---|---|---|---|---|---|---|---|---|
| Experiment | of example | Temperature | Time | Cooling | strength | Elongation | Rebound | Density |
| Nr. | 11 | [° C.] | [min] | [min] | [MPa] | [%] | [%] | [g/cm³] |
| 19-1 | 5% | 140 | 10 | 5 | 1.24 | 233 | 66 | 0.26 |
| C15-2 | 0% | 140 | 10 | 5 | 0.7 | 100 | 73 | 0.29 |

### Example 20

170 g of E-TPU beads, according to WO2013/153190 A1, example 1, having a bulk density 130 g/l and a particle weight of 27 mg (Infinergy 230 based on Diisocyanate 4, BDO, and Polyol 1, company BASF SE), coated with 10 w/w % of the dispersion of example 2, were placed in a 15 cm high cylinder of 11 cm in diameter. An 800 g heavy lid was placed on the filled cylinder, which was stored at room temperature.

After 10 days the lid was removed, and the coated particles were released. No agglomeration or caking were observed.

The same experimental set up was used for evaluating the agglomeration behavior of the coated beads over a time of 3 months. The coated beads could flow out without agglomeration also after 3 months of storage.

As a reference, 170 g of E-TPU beads, according to WO2013/153190 A1 (Infinergy 230 based on Diisocyanate 4, BDO, and Polyol 1, company BASF SE), were placed in a 15 cm high cylinder of 11 cm in diameter. An 800 g heavy lid was placed on the filled cylinder, which was stored at room temperature for 10 days. Upon remotion of the lid the beads did no flow out of the cylinder and mechanical stirring was necessary for destroying the agglomerate.

Thus, the coated beads show the positive phenomenon of avoiding agglomeration upon storage under defined pressure.

### Example 21

50 g of E-TPU beads, according to WO2013/153190 A1, Example 1, (Infinergy 230 based on Diisocyanate 4, BDO, and Polyol 1, company BASF SE), coated with 15 w/w % of the dispersion of example 2, were places in contact with a Teflon foil. The coated beads were shacked for a period of time of 2 minutes in order to electrostatically charge them. After that the coated beads were let flow away from the Teflon foils and collected in a jar. No electrostatic charging of the beads was observed, and the coated beads could be removed from the teflon support easily. As a reference 50 g of E-TPU beads, according to WO2013/153190 A1, were places in contact with a Teflon foil. The coated beads were shacked for a period of time of 2 minutes in order to electrostatically charge them. The E-TPU beads showed strong electrostatic charging and could not flow away from the Teflon foil, but sticked to it without flowing away.

Thus, the coated beads show the advantage of avoiding electrostatic charging and can be used for application where no antistatic is required.

### Example 22

60 g of the dispersion according to experiment 2 were mixed with 20 g of Exolit AP 422 (from the company Clariant).

200 g of E-TPU beads, according to WO2013/153190 A1, example 1, were placed in a kitchen Mixer (Bosch), equipped with a dough hook. The beads and the dispersion containing Exolit AP 422 were mixed for 10 minutes, until the complete evaporation of water.

65 g of the obtained coated beads were placed in a preheated mold of dimension (16.3×9.6×3.3) cm³ (length, bright, depth), which was previously sprayed with Indrosil 2000 as release agent. The filled mold was covered with a mold lid (also sprayed with Indrosil 2000), which allows a compression/compactaction of 50%. The time in the heated press and the residual time for cooling down the 3 D parts prior to demolding are summarized in the following table.

| | Coating | | Heating | | Tensile | | |
|---|---|---|---|---|---|---|---|
| Experiment | According to | Temperature | Time | Cooling | strength | Elongation | Density |
| Nr. | exp. 18 | [° C.] | [min] | [min] | [MPa] | [%] | [g/cm³] |
| 22-1 | 22% | 140 | 10 | 5 | 0.72 | 176 | 0.27 |

The experiment shows that the inclusion of a flame retardant in the coating is possible and that this results into 3 D parts with good mechanical stability.

1. A process for the preparation of storage-stable coated particles of a moldable thermoplastic particle foam comprising:
a₁) bringing particles of a moldable thermoplastic particle foam into contact with an aqueous polyurethane dispersion, the polyurethane in the dispersion having a K-value according to DIN EN ISO 1628-1 2021 in the range from higher than 50 to lower than 100, resulting in at least partly coated particles;
a₂) drying the at least partly coated particles.

2. The process of claim 1, wherein the moldable thermoplastic particle foam is an expanded thermoplastic elastomer.

3. The process of claim 2, wherein the expanded thermoplastic elastomer is expanded thermoplastic polyurethane.

4. The process of claim 1, wherein the aqueous polyurethane dispersion has a solid content of at least 40 wt.-% based on the total weight of the dispersion.

5. The process of claim 1, wherein the aqueous polyurethane dispersion has a viscosity of less than 300 mPas at 23° C. measured according to DIN EN ISO 3219-2:2021 at 23° C. and a shear rate of 250 s⁻¹.

6. The process of claim 1, wherein the polyurethane of the aqueous polyurethane dispersion has a glass transition temperature T_{g} according to DIN EN ISO 11357-2 (2014) of below 0° C.

7. The process of claim 1, wherein the polyurethane has at least a first glass transition temperature T_{g1} and a second glass transition temperature T_{g2}, wherein T_{g1} is below 0° C. and T_{g2} is higher than 25° C.

8. The process of claim 1, wherein the polyurethane of the aqueous polyurethane dispersion has a melting temperature Tₘ according to DIN EN ISO 11357-3 (2018) of in the range from 30° C. to 100° C.

9. The process of claim 1, wherein the polyurethane of the aqueous polyurethane dispersion is prepared from
a) at least one organic diisocyanate, selected from diisocyanates of the formula X(NCO)₂, where X is a noncyclic aliphatic hydrocarbon radical having 4 to 15 carbon atoms, a cycloaliphatic hydrocarbon radical having 6 to 15 carbon atoms, an aromatic hydrocarbon radical having 6 to 15 carbon atoms, or an araliphatic hydrocarbon radical having 7 to 15 carbon atoms, wherein the amount of aromatic diisocyanates is less than 60 mol-%, based on the sum of all organic diisocyanates a),
b) at least one dihydroxy compound selected from the group consisting of polyesterdiols and polytetrahydrofuran,
c) at least one compound having at least one group reactive toward isocyanate groups, and additionally carrying at least one ionic group or one group which can be converted into an ionic group, and
d) optionally further compounds different from a) to c).

10. The process of claim 9, wherein the aqueous polyurethane dispersion comprises at least one additive selected from the group consisting of ionic surfactants, nonionic surfactants, rheology modifiers, fillers, anti-blocking additives, other aqueous dispersions, crosslinkers, plasticizers, stabilizers against hydrolytic degradation, antifoam agents and biocides.

11. The process of claim 1, wherein in a₁) the bringing into contact is realized by mixing or spraying.

12. The process of claim 1, wherein the at least partly coated particles are coated in an amount of from 0.1 wt.-% to 40 wt.-% based on the total weight of particle and coating.

13. The process of claim 1, wherein during step a₂) the at least partly coated particles are kept moving.

14. The process of claim 1, wherein after a₁) and before a₂) the particles are separated from each other in order to prevent agglomeration of the particles.

15. A process for the preparation of a shaped body comprising:
b1) coating of particles of an expanded thermoplastic elastomer according to the process of claim 1;
b2) shaping the particles obtained from b₁).

16. The process of claim 15, wherein the shaping in step b₂) is carried out by steam-less thermo-pressing.

17. (canceled)

18. The process of claim 15, wherein the shaping is carried out by heat, wherein the heat is produced partly or completely by an electro-magnetic field in the range of 30 kHz to 300 MHz.

19. (canceled)

20. A method for disposing a shaped body comprising:
c₁) preparing a shaped body according to the process of claim 15;
c₂) disassembling the particles by subjecting the shaped body to an alkaline aqueous fluid.

21. A storage-stable, at least partly coated particle of a moldable thermoplastic particle foam, wherein the coating is a dried aqueous polyurethane dispersion and wherein the polyurethane has a K-value according to DIN EN ISO 1628-1 2021 in the range from higher than 50 to lower than 100.

22. A shaped body comprising storage-stable, at least partly coated particles according to claim 21.
